(19) United States
(12) Patent Application Publication
(10) Pub. No.: US 2025/0371869 A1
(43) Pub. Date: Dec. 4, 2025

(54) SYSTEMS AND METHODS FOR DETECTING AND CATEGORIZING GRAPHIC CONTENT IN VEHICLE VIDEOS

(71) Applicant: Verizon Patent and Licensing Inc., Basking Ridge, NJ (US)

(72) Inventors: Andrea BENERICETTI, Prato (IT); Leonardo SARTI, Florence (IT); Stefano NATALI, Florence (IT)

(73) Assignee: Verizon Patent and Licensing Inc., Basking Ridge, NJ (US)

(21) Appl. No.: 18/680,988

(22) Filed: May 31, 2024

(51) Int. Cl. G06V 20/40; G06F 40/40; G06T 5/70; G06V 20/58; G06V 20/59

(52) U.S. Cl. CPC G06V 20/41; G06F 40/40; G06T 5/70; G06V 20/44; G06V 20/46; G06V 20/58; G06V 20/59; G06T 2207/10016; G06T 2207/30261; G06T 2207/30268

(57) ABSTRACT

A device may receive video data associated with a vehicle experiencing an event, and may determine object data identifying bounding boxes, tracks, and labels for objects in the video data. The device may calculate sensitivity scores indicating a likelihood that a person inside the vehicle is injured, a likelihood that a person outside the vehicle is injured, a likelihood that an animal is injured, or a dangerousness of the event, and may aggregate the sensitivity scores to generate an aggregated score. The device may horizontally concatenate a subset of frames of the video data to generate an input image, and may generate queries about whether the video data contains graphic content. The device may process the input image and the queries, with a multi-modal large language model, to determine whether the video data contains graphic content, and may perform actions when the video data contains graphic content.

### BACKGROUND

Provisioning of dashcams in vehicles has become increasingly common, with both enterprise fleets and private vehicle owners using these cameras to record hours of driving footage. Dashcam systems often include both forward or front facing cameras (FFCs) capturing a road ahead of a vehicle and driver facing cameras (DFCs) capturing a cabin of the vehicle.

### BRIEF DESCRIPTION OF THE DRAWINGS

FIGS. 1A-1H are diagrams of an example associated with detecting and categorizing graphic content in vehicle videos.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for detecting and categorizing graphic content in vehicle videos.

### DETAILED DESCRIPTION OF EXAMPLE EMBODIMENTS

The following detailed description of example implementations refers to the accompanying drawings. The same reference numbers in different drawings may identify the same or similar elements.

With an escalating volume of recorded road events, chances of dashcam video footage containing graphic content (e.g., unsettling, violent, explicit, gruesome, sensitive, and/or the like content) rise significantly. Such graphic content could potentially be distressing to viewers, such as fleet safety managers or others responsible for monitoring and reviewing these videos. Analyzing dashcam video footage to identify graphic content typically relies on manual review by individuals who, through the process, are susceptible to negative psychological impact. Moreover, the process of manually sifting through extensive video footage to identify graphic content is time consuming and inefficient. Additionally, automatic graphic content detection systems may require training with supervised learning techniques, which also necessitates human labelers to watch and tag hours of potentially graphic content, exacerbating the mental health risks. Furthermore, beyond the immediate challenge of identifying graphic content, there lies a privacy and ethical issue of ensuring that graphic content is not easily downloadable or shareable inadvertently to protect the privacy and dignity of those involved.

Thus, current techniques for detecting graphic content in vehicle videos consume computing resources (e.g., processing resources, memory resources, communication resources, and/or the like), networking resources, and/or other resources associated with handling mental health issues associated with reviewers of the vehicle videos that contain graphic content, addressing the privacy and ethical issue associated with ensuring that graphic content is not downloadable or shareable, training automatic graphic detection systems with human labelers that are susceptible to mental health issues, and/or the like.

Some implementations described herein provide a video system that detects and categorizes graphic content in vehicle videos. For example, the video system may receive video data associated with a vehicle experiencing an event, and may determine object data identifying bounding boxes, tracks, and labels for objects depicted in the video data. The video system may calculate, based on the video data and the object data, sensitivity scores indicating a likelihood that a person inside the vehicle is injured, a likelihood that a person outside the vehicle is injured, a likelihood that an animal is injured, or a dangerousness of the event. The video system may aggregate the sensitivity scores to generate an aggregated score, and may determine whether the aggregated score satisfies a threshold. The video system may horizontally concatenate (e.g., combine), based on the aggregated score satisfying the threshold, a subset of frames of the video data to generate an input image, or may discard the video data based on the aggregated score failing to satisfy the threshold. The video system may generate, based on the sensitivity scores, one or more queries about whether the video data contains graphic content, and may process the input image and the one or more queries, with a multi-modal large language model (MMLLM), to determine whether the video data contains graphic content. The video system may perform one or more actions based on the video data containing graphic content, or may discard the video data based on the video data not containing graphic content.

In this way, the video system detects and categorizes graphic content in vehicle videos. For example, the video system may preemptively analyze vehicle videos using an MMLLM to detect and categorize graphic content, thus reducing the need for human reviewers to be exposed directly to such content. For example, the video system may detect a set of candidate frames in a vehicle video that potentially contain graphic content based on aggregated sensitivity scores derived from object detection models and vehicle sensor data. The sensitivity scores may correlate with scenarios, such as a person injured inside or outside the vehicle, a hurt animal, or a dangerous event. The video system may compile an image storyboard by horizontally concatenating selected frames (e.g., rows or columns) of the vehicle video and may employ tailored queries to enable the MMLLM to ascertain the presence of graphic content. Additionally, the video system may implement a selective masking operation on the storyboard image, wherein portions of the frame that are irrelevant to the analysis are obscured, concentrating efforts of the MMLLM on areas with potential graphic content and conserving processing resources.

Thus, the video system may conserve computing resources, networking resources, and/or other resources that would have otherwise been consumed by handling mental health issues associated with reviewers of the vehicle videos that contain graphic content, addressing the privacy and ethical issue associated with ensuring that graphic content is not downloadable or shareable, training automatic graphic detection systems with human labelers that are susceptible to mental health issues, and/or the like. The video system may significantly reduce the workload on processing resources by efficiently identifying frames of interest within extensive video data, and may conserve memory resources and network bandwidth that would be otherwise required for the transfer and storage of extensive unfiltered video data. Moreover, the video system controls the dissemination of graphic content, thereby potentially preventing a breach of privacy and ensuring the dignity of individuals captured in the vehicle videos.

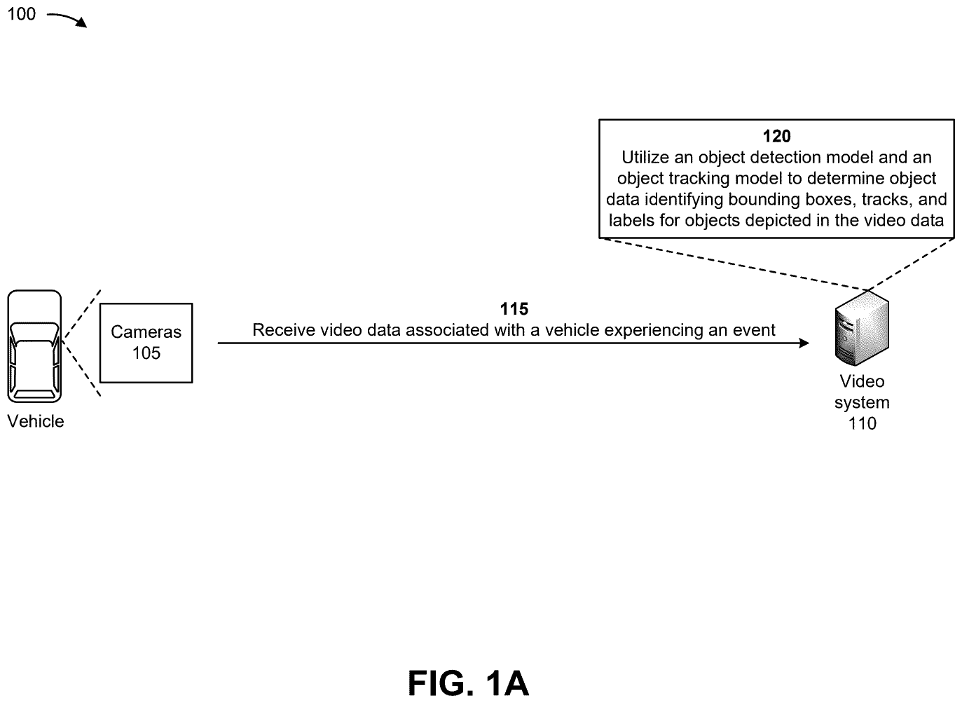

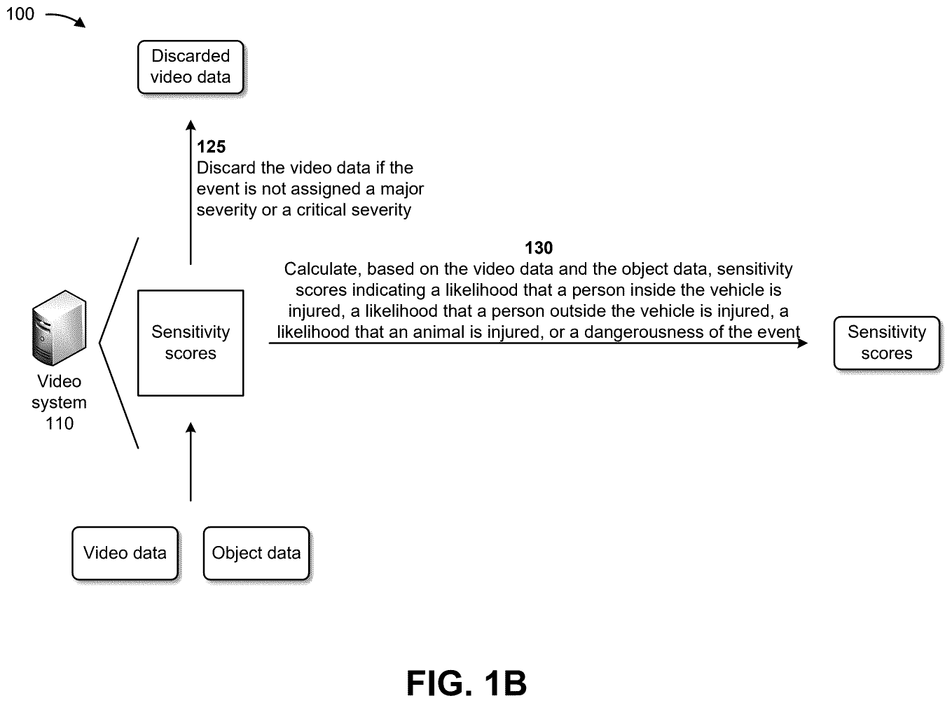

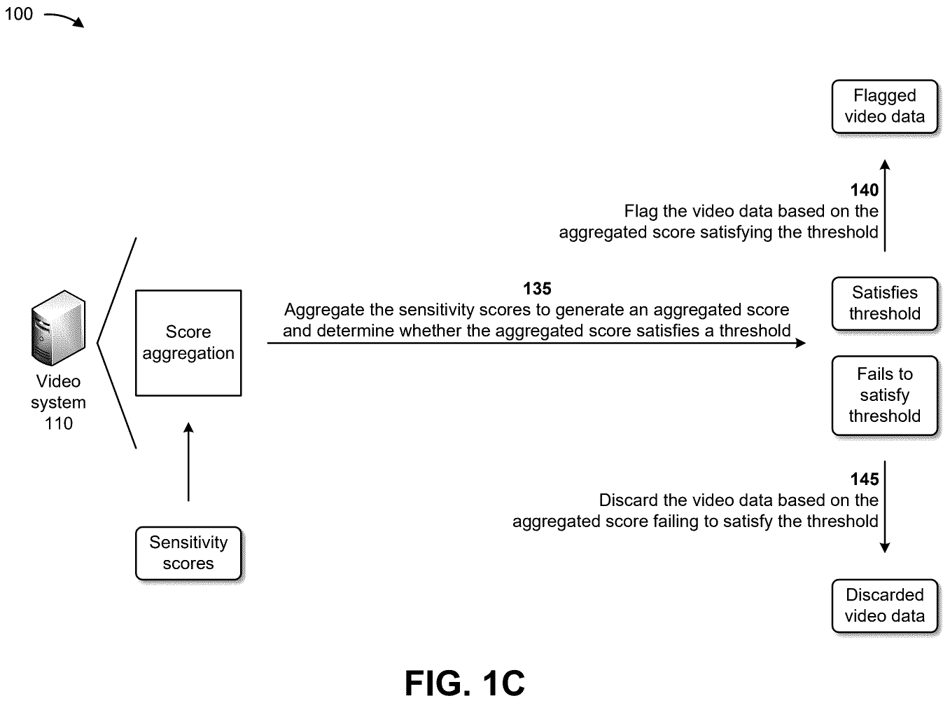

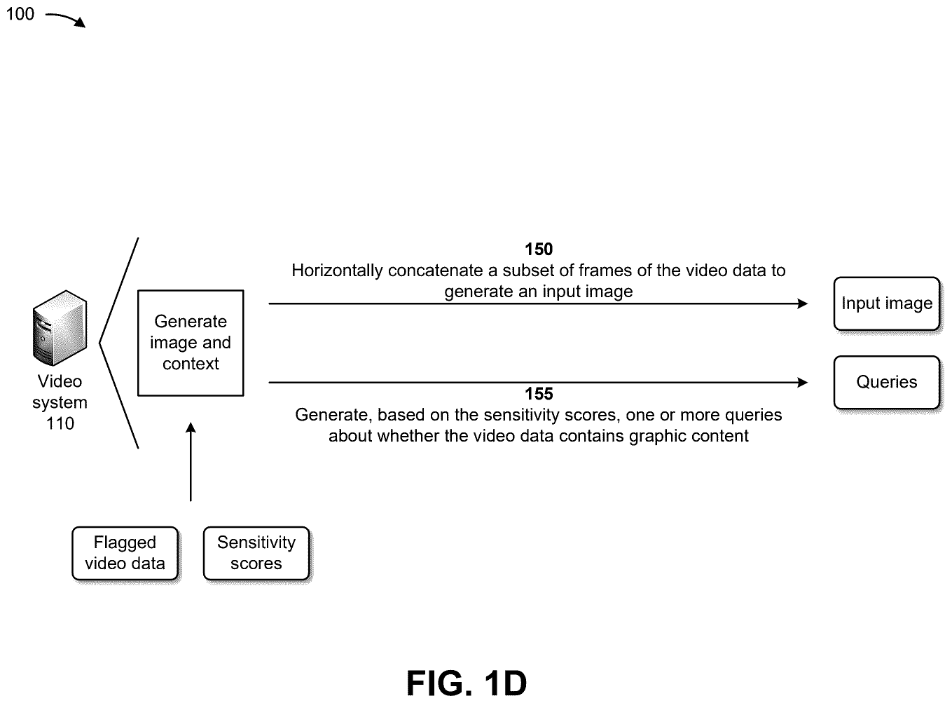

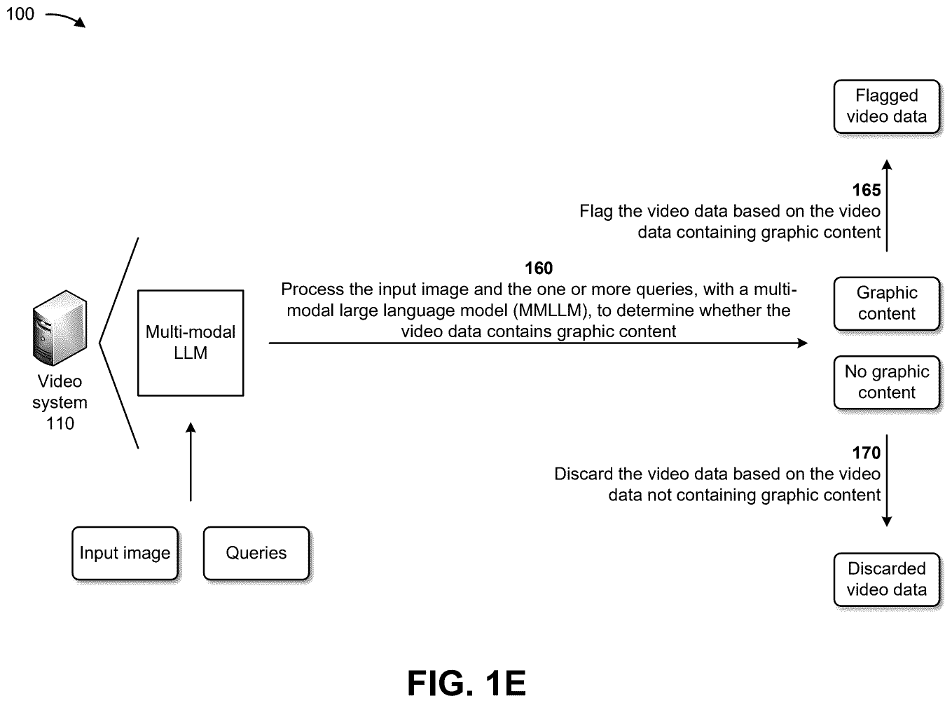

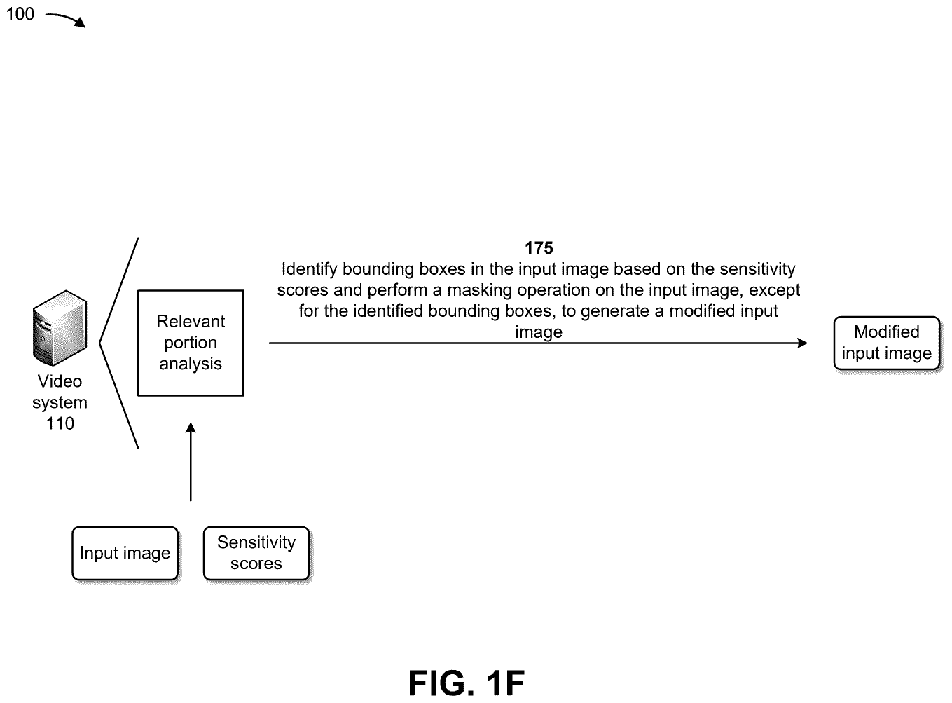

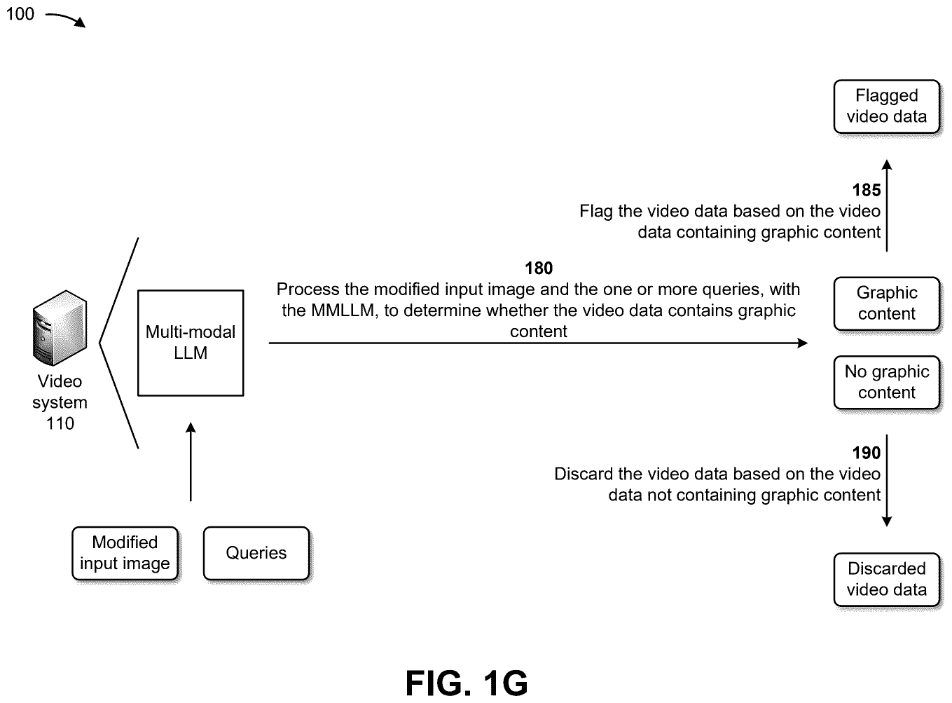

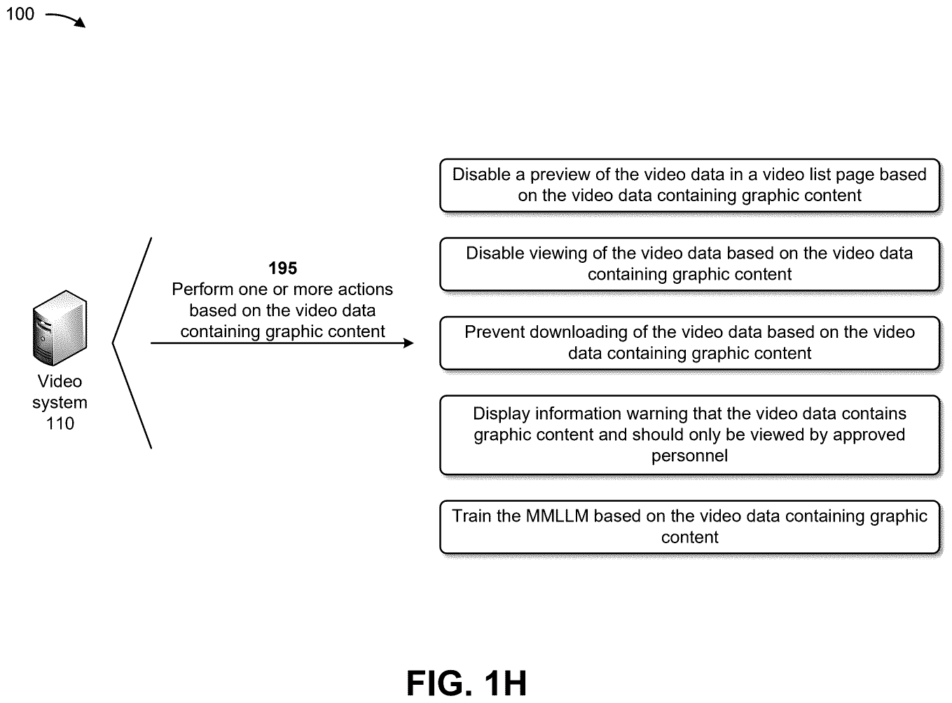

FIGS. 1A-1H are diagrams of an example 100 associated with detecting and categorizing graphic content in vehicle videos. As shown in FIGS. 1A-1H, example 100 includes cameras 105 associated with a vehicle and a video system 110. The cameras 105 may capture video of objects (e.g., pedestrians, traffic signs, traffic signals, road markers, a driver, animals, and/or the like) associated with the vehicle. The cameras 105 may include a dashcam of the vehicle, a forward-facing camera of the vehicle, a driver-facing camera of the vehicle, a side camera of the vehicle, a rear camera of the vehicle, and/or the like. The video system 110 may include a system that receives and processes video generated by the cameras 105. Further details of the cameras 105 and the video system 110 are provided elsewhere herein. Although implementations described herein depict a single vehicle, in some implementations, the video system 110 may be associated with multiple vehicles.

As shown by FIG. 1A, and by reference number 115, the video system 110 may receive video data associated with a vehicle experiencing an event. For example, the video system 110 may receive video data from the cameras 105 provided on the vehicle (e.g., a forward facing camera, a driver facing camera, a side camera, a rear camera, and/or the like) when an event (e.g., an abrupt acceleration, abrupt braking, a collision, a drowsiness detection, and/or the like) triggers recording of the video data. The event-based recording of the video data may ensure that significant incidents are captured for later review and analysis, which is particularly useful for enterprise fleet management and safety monitoring.

In some implementations, once an event (e.g., a dangerous situation) is detected, the video system 110 may receive the video data from the cameras 105 footage and may process the video data with an artificial intelligence-based pipeline (e.g., a video analytics engine) to produce a series of tags for the video data, to determine a severity of the event, and to add contextual data (e.g., entities on the road, anomalous driver behaviors, and/or the like) to the video data. In some implementations, it may be likely that any occurrence of a disturbing and/or violent event (e.g., crashes with other vehicles and collisions with pedestrians, animals and other vulnerable road users) will trigger an event, resulting in graphic content being provided in the video data.

As further shown in FIG. 1A, and by reference number 120, the video system 110 may utilize an object detection model and an object tracking model to determine object data identifying bounding boxes, tracks, and labels for objects depicted in the video data. Object detection is a popular approach as a first step in a video analysis pipeline, since an object detection model enables determination of information about what appears in a video segment and where each entity is located in the video segment. Furthermore, an object tracking model may link together bounding boxes associated to the same entity in different frames across the video data, and may generate a full semantic description of the evolution of the entity in the video data. In this way, at any point in time, the object tracking model may provide a position, a velocity, and a distance from a camera 105 (e.g., approximated through the bounding box size) of every object. For example, the video system 110 may receive and process the video data to detect and track various objects, categorizing the objects with appropriate labels, such as person, animal, vehicle, and/or the like, based on characteristics of the objects. This may enable the video system 110 to create an organized dataset, laying the groundwork for subsequent analysis steps, such as identifying potential graphic content and facilitating the efficient extraction of relevant information from the video data.

In some implementations, the object data may include additional features or details based on other sensors or inputs, such as telematics sensor data that provides contextual dynamics of the vehicle during the event. For example, if telematics data indicates a sudden stop or a sharp change in vehicle direction, the video system 110 can prioritize analyzing frames around this time period, presuming a higher likelihood of capturing an event of interest. In some implementations, one or more of the cameras 105 may include the object detection model and the object tracking model, and may utilize the object detection model and the object tracking model to determine the object data identifying the bounding boxes, the tracks, and the labels (e.g., person, car, truck, and/or the like) for the objects depicted in the video data.

The determination of the object data provides a comprehensive and automated initial assessment of the event, which, among other things, aids in protecting viewer sensitivity by filtering out irrelevant content and focusing on potentially significant occurrences that warrant further examination. The determination of the object data also saves valuable time and resources by preventing a manual review of the entire video data and reducing exposure to potentially graphic content, which is especially beneficial for safety managers who handle extensive fleets.

As shown in FIG. 1B, and by reference number 125, the video system 110 may discard the video data if the event is not assigned a major severity or a critical severity. For example, the video system 110 may determine a severity of the event based on the video data, telematics sensor data of the vehicle, and/or the like. The determination of the severity of the event may be based on various factors, such as vehicle dynamics, visual cues from the video data, or outputs from the video analytics engine. If the severity of the event fails to satisfy a predetermined criteria for major severity or critical severity, the video system 110 may discard the video data, effectively ceasing any further processing with regard to that particular footage. In this way, the video system 110 may reduce processing load and focus resources on events that are more likely to contain graphic content.

As further shown in FIG. 1B, and by reference number 130, the video system 110 may calculate, based on the video data and the object data, sensitivity scores indicating a likelihood that a person inside the vehicle is injured, a likelihood that a person outside the vehicle is injured, a likelihood that an animal is injured, or a dangerousness of the event. For example, the video system 110 identifies scenarios in which graphic content might be included in the video data, a person inside the vehicle is injured, a person outside the vehicle is injured, an animal is injured, or a dangerousness of the event (e.g., a crash or a dangerous near-miss occurs). The video system 110 may utilize the video data, the object data, telematics sensor data, and output of the video analytics engine output to calculate the sensitivity scores indicating a likelihood that a person inside the vehicle is injured, a likelihood that a person outside the vehicle is injured, a likelihood that an animal is injured, or a dangerousness of the event. Each sensitivity score may be calculated based on a video chunk (e.g., a few seconds in duration) and then aggregated through the video data in a rolling fashion. If a particular video segment includes a high value for one of the sensitivity scores, the video system 110 may determine that graphic content is likely to be present in the particular video segment, and may flag frames of the particular video segment as good candidates for further analysis. A first sensitivity score (S_{person inside}) may measure a likelihood that a person inside the vehicle is injured, a second sensitivity score (S_{person outside}) may measure a likelihood that a person outside the vehicle is injured, a third sensitivity score (Sₐₙᵢₘₐₗ) may measure a likelihood that an animal is injured, and a fourth sensitivity score (S_{danger}) may measure dangerousness of the event.

In some implementations, the first sensitivity score (S_{person inside}) may be calculated according to S_{person inside}=ShakingScore. For each object @ (e.g., independently from its class) detected by the object detection model and tracked in a scene in the video data, the video system 110 may calculate variances of a center (ω of its x, ωy) of a bounding box in the horizontal and vertical directions, a total distance traveled by the center in a two-dimensional space, and sum these three values. The ShakingScore may include a median of the resulting distribution of values:

$$ShakingScore = {median}_{ω ∈ objects} \{ Var ( {ω}_{x} ) + Var ( {ω}_{y} ) + TravelDistance ( ω ) \} .$$

All scenarios where a sudden impact moves everything in the cabin and/or shakes the camera will result in a high ShakingScore. Such strong impacts are likely to result in people inside the vehicle being injured, and are therefore worth analyzing.

In some implementations, the second sensitivity score (S_{person outside}) may be calculated according to S_{person outside}=TTCMinₚₑᵣₛₒₙ+BBoxAreaMaxₚₑᵣₛₒₙ+HitAwayScoreₚₑᵣₛₒₙ. TTCMin_{class} may represent a minimum of a time to contact value for all objects of a class, and may capture how fast the vehicle is moving towards the objects on the road and how likely it is that at least one object will be struck by the vehicle. A maximum of the bounding box areas for a specific class (e.g., an animal or a person) in the time window may be calculated as follows:

$${BBoxAreaMax}_{class} = {max}_{ω ∈ class} {BBoxArea}_{ω} .$$

The maximum of the bounding box areas may be high when there is an object that for at least one frame is close to a subject, since the bigger the bounding box, the closer the object is to the camera 105.

When the vehicle strikes an entity on a road, like a person or an animal, usually the entity may be moved quickly in some direction, even outside the field of view of the camera 105. In this case, an area of a bounding box of the entity may shrink quickly and a center of the bounding box may move rapidly upwards. The video system 110 may calculate the HitAwayScore as follows:

$${HitAwayScore}_{class} = {max}_{ω ∈ class} ( - ( {BBoxArea}_{ω}^{f = n} - {BBoxArea}_{ω}^{f = 1} ) ( {ω}_{y}^{f = n} - {ω}_{y}^{f = 1} ) ) .$$

This score will be high when there is an object such that the area of its bounding box is greater on a first frame than on a last frame of the time window, and a y coordinate of its center (e.g., assuming a reference system centered on the bottom-left corner of the video) is greater on the last frame than on the first frame. Such a behavior occurs when an object is hit away from the subject, as seen from the perspective of the driver.

In some implementations, the third sensitivity score (Sₐₙᵢₘₐₗ) may be calculated according to Sₐₙᵢₘₐₗ=TTCMinₐₙᵢₘₐₗ+ (BBoxAreaMaxₐₙᵢₘₐₗ*Cardinalityₐₙᵢₘₐₗ)+HitAwayScoreₐₙᵢₘₐₗ. TTCMin, BBoxAreaMax, and HitAwayScore are described above. A maximum quantity of distinct objects belonging to a specific class (e.g., animal) that appear in a frame may be calculated as follows:

$${Cardinality}_{class} = {max}_{f ∈ frames} \vert \{ {ω}^{f} \vert {ω}^{f} ∈ class \} \vert .$$

In the third sensitivity score (Sₐₙᵢₘₐₗ), this value may be used to weigh BBoxAreaMaxₐₙᵢₘₐₗ, in order to capture scenarios with multiple small animals or one single big animal. In this way, scenarios with just one small animal (e.g., birds flying by) may be omitted since such scenarios are not likely to present a real threat to safety.

In some implementations, the fourth sensitivity score (S_{danger}) may be calculated according to S_{danger}=TTCMinₐₗₗ+BBoxAreaMaxₐₗₗ+GSensorVariance+GSensorAbsolutePeak+StopTime. TTCMin and BBoxAreaMax are described above. GSensorVariance may include a variance of G-sensor values (e.g., an acceleration) in a time segment, which may capture crashes or severe near-miss events that generate high acceleration or deceleration variance values. GSensorAbsolutePeak may include a maximum absolute value of the G-sensor values across time in the time segment, which may capture crashes or severe near-miss events that produce high absolute acceleration values. StopTime may include a duration of idling time for the vehicle during the time segment. In case of a strong collision, a vehicle is likely to stop if there is an actual crash, a severe near-miss, or if an entity on the road is struck, and a vehicle may not stop if the vehicle hits a curb or experiences a light crash (e.g., a fender bender).

As shown in FIG. 1C, and by reference number 135, the video system 110 may aggregate the sensitivity scores to generate an aggregated score and determine whether the aggregated score satisfies a threshold. For example, the video system 110 may utilize the sensitivity scores to assess a likelihood that a corresponding sensitive event (e.g., driver and/or passengers being injured, pedestrians being injured, animals being injured, or a generally dangerous situation) occurs in the video data. In one example, the video system 110 may calculate the sensitivity scores using a rolling window (e.g., of four seconds), with a step (e.g., of one second), on videos of a length (e.g., sixteen seconds). In such an example, each sensitivity score may include thirteen point values. These parameters are arbitrary and can be tuned to better fit application requirements, and the length of the video data does not affect the applicability or the results of the approach.

In some implementations, the video system 110 may independently normalize each set of sensitivity scores using a min-max normalization procedure to translate the values into an interval [0, 1]. If at least one of the sensitivity scores has a quantity (e.g., at least three) of consecutive values above a threshold (e.g., 0.7), the video system 110 may flag the event as a potential candidate for graphic content associated with a category of the one of the sensitivity scores. Multiple categories (e.g., animal and generic danger) may be candidates for the same video data. In some implementations, danger may always be one of the selected categories, otherwise the video data may be discarded. This is useful for reducing a quantity of false positives, since it is highly unlikely that the video data contains graphic content if no danger is detected.

In some implementations, the video system 110 may combine or aggregate (e.g., sum) the sensitivity scores into a singular aggregated score. Aggregating these scores into a singular aggregated score allows for a more comprehensive assessment of the event's severity by the video system 110. The aggregation process may be key in filtering incidents needing further analysis, as only those incidents with aggregated scores meeting specific criteria may proceed to a next analysis phase. For example, the video system 110 may determine whether the aggregated score satisfies a threshold in order to assess whether the event captured in the video data is severe enough to potentially contain graphic content. In some implementations, the video system 110 may determine that the aggregated score satisfies the threshold (e.g., indicating that the video data may contain graphic content). Alternatively, the video system 110 may determine the aggregated score fails to satisfy the threshold (e.g., indicating that the video data is unlikely to contain graphic content).

As further shown in FIG. 1C, and by reference number 140, the video system 110 may flag the video data based on the aggregated score satisfying the threshold. For example, when the video system 110 determines that the aggregated score satisfies the threshold (e.g., indicating that the video data may contain graphic content), the video system 110 may flag the video data for further processing and analysis. Thus, the video system 110 may identify and segregate video data that is likely to contain graphic content. Depending on the sensitivity scores and the threshold, the video system 110 may flag the video data for further actions, such as an in-depth review using an MMLLM or other sensitive content handling protocols.

As further shown in FIG. 1C, and by reference number 145, the video system 110 may discard the video data based on the aggregated score failing to satisfy the threshold. For example, when the video system 110 determines that the aggregated score fails to satisfy the threshold (e.g., indicating that the video data is unlikely to contain graphic content), the video system 110 may discard the video data. The discarding of video data may enable the video system 110 to manage a significant volume of video footage captured by multiple cameras 105 of multiple vehicles. In this way, the video system 110 may ensure that only relevant video data that meets the criteria for potential graphic content is retained for further review, thus optimizing the resources of the video system 110.

As shown in FIG. 1D, and by reference number 150, the video system 110 may horizontally concatenate a subset of frames of the video data to generate an input image. For example, the video system 110 may generate the input image by concatenating horizontally a subset of the frames of the video data (e.g., one frame every second). In some implementations, the input image may include a “storyboard” of the video data. Depending on the sensitivity scores associated with the flagged video data, the video system 110 may extract the input image from driver facing video data, forward facing video data, or both driver facing video data and forward facing video data. The horizontal concatenation may include framing selected video segments of the video data in a continuous sequence to form a comprehensive input image that reflects a progression of the recorded event. The sensitivity scores may serve as a guide that enables the video system 110 to discern pertinent frames (e.g., the subset of frames) of the video data that satisfy the threshold for further analysis.

As further shown in FIG. 1D, and by reference number 155, the video system 110 may generate, based on the sensitivity scores, one or more queries about whether the video data contains graphic content. For example, the one or more queries may be provided to an MMLLM as a prompt, as described below. However, in order for the MMLLM to generate useful responses, the one or more queries need to provide context for the MMLLM. The video system 110 may extract such context from the sensitivity scores that triggered the analysis. Assuming that the fourth sensitivity score (S_{danger}) be one of the sensitivity scores, examples of the one or more queries may include the following: “Suppose you are an average sensitive person, and you are watching the video from which this picture is extracted showing a dangerous event involving a vehicle. Would you feel uncomfortable watching it?”; “In this image, where a dangerous driving event is recorded from inside the vehicle cabin, is there any sensitive content?”; “Does this image, showing a vehicle involved in a dangerous event with a person, contain any sensitive content?”; and “This picture shows a dangerous event involving a vehicle and an animal. Is there anything graphic in it?”

In case an event is selected as a candidate for multiple reasons (e.g., multiple sensitivity scores above the threshold), the video system 110 may concatenate the one or more queries together. Alternatively, the video system 110 may generate a set of queries for all possible combinations of sensitivity scores. For example, the video system 110 may utilize the following combinations: (S_{danger}, S_{danger}+S_{person inside}, S_{danger}+S_{person outside}, S_{danger}+Sₐₙᵢₘₐₗ, S_{danger}+S_{person inside}+S_{person outside}, S_{danger}+S_{person inside}+Sₐₙᵢₘₐₗ, S_{danger}+S_{person outside}+Sₐₙᵢₘₐₗ, S_{danger}+S_{person inside}+S_{person outside}+Sₐₙᵢₘₐₗ). If the MMLLM answers positively (e.g., “Yes” and/or equivalents) to the one or more queries, then the video system 110 may mark the video data as including graphic content. Otherwise, the video system 110 may discard the video data. The above queries are only examples, and the video system 110 may utilize different queries than the above queries. For example, the video system 110 might generate consecutive queries with several slightly different prompts (e.g., slightly changing the wording or phrasing, without affecting the general scope), and then may aggregate responses from the MMLLM with a majority voting technique. In some implementations, the interplay of the one or more queries and the input image may facilitate a thorough analysis by the MMLLM, ensuring that the video data is carefully examined for graphic content.

As shown in FIG. 1E, and by reference number 160, the video system 110 may submit the input image and the one or more queries as a prompt to the MMLLM, and the MMLLM may process the input image and the one or more queries to determine whether the video data contains graphic content. For example, an MMLLM is capable of summarizing, understanding, and elaborating written content. An MMLLM is a subcategory of an LLM that can process multiple types of input at the same time, such as text and images, text and audio, text and video, and/or the like. The video system 110 may utilize the capabilities of the MMLLM for interpreting visual and textual data to assess, based on the one or more queries, the presence of graphic content within the input image derived from the video data. The one or more queries processed by the MMLLM may be formulated based on the sensitivity scores, to provide context to the MMLLM and to enhance an accuracy of the graphic content detection by the MMLLM. The video system 110 may leverage the advanced interpretative analytics of the MMLLM to evaluate the input image against the one or more queries, ensuring that content identified as potentially containing graphic content is accurately detected. In some implementations, the MMLLM may determine that the video data contains graphic content. Alternatively, the MMLLM may determine that the video data does not contain graphic content.

As further shown in FIG. 1E, and by reference number 165, the video system 110 may flag the video data based on the video data containing graphic content. For example, when the MMLLM determines that the video data contains graphic content, the video system 110 may flag the video data by marking the video data for special treatment, such as restricting access or providing warnings to viewers, in accordance with the content moderation policies and safety considerations. Flagging the video data may enable the video system 110 to manage the distribution of graphic content and to mitigate the exposure of viewers to potentially harmful content.

As further shown in FIG. 1E, and by reference number 170, the video system 110 may discard the video data based on the video data not containing graphic content. For example, when the MMLLM determines that the video data does not contain graphic content, the video system 110 may discard the video data or abstain from applying, to the video data, any special considerations relevant to graphic content. By discarding the video data or abstaining from censoring the video data, the video system 110 may streamline the content management process by ensuring that only content flagged as graphic is subjected to further scrutiny or restrictive measures.

As shown in FIG. 1F, and by reference number 175, the video system 110 may identify bounding boxes in the input image based on the sensitivity scores and may perform a masking operation on the input image, except for the identified bounding boxes, to generate a modified input image. For example, the video system 110 may utilize a more refined technique to generate the input image. The technique may generate a modified input image that enables the video system 110 to know what graphic content appeared in the video data and where the graphic content appeared in the video data. If the video data has a high first sensitivity score (S_{person inside}), the video system 110 may extract bounding boxes of all people appearing in the video data (e.g., drivers and/or passengers), may horizontally concatenate the bounding boxes, and may query the MMLLM separately for each bounding box. If the video data has a high second sensitivity score (S_{person outside}), the video system 110 may extract bounding boxes of all people appearing in the video data (e.g., outside the vehicle), may horizontally concatenate the bounding boxes, and may query the MMLLM separately for each bounding box. If the video data has a high third sensitivity score (Sₐₙᵢₘₐₗ), the video system 110 may extract bounding boxes of all animals appearing in the video data, may horizontally concatenate the bounding boxes, and may query the MMLLM separately for each bounding box. If the video data has a high fourth sensitivity score (S_{danger}), the video system 110 may analyze the frames as a whole. If at least one of the queries yields a positive answer from the MMLLM, the video system 110 may mark the video data as containing graphic content sensitive and may identify which part of the video data contains the graphic content.

In some implementations, the video system 110 may apply a selective masking operation on the video data before the concatenation operation described above. If the video data has a high first sensitivity score (S_{person inside}), for each frame in the video data, the video system 110 may mask (e.g., black out) all pixels not belonging to a person bounding box. If the video data has a high second sensitivity score (S_{person outside}), for each frame in the video data, the video system 110 may mask all pixels not belonging to a person bounding box. If the video data has a high third sensitivity score (Sₐₙᵢₘₐₗ), for each frame in the video data, the video system 110 may mask all not belonging to an animal bounding box. After this operation, the masked input image may be processed by the MMLLM as described above. By filtering out non-relevant content, the video system 110 may enable the MMLLM to focus only on elements identified as potential graphic content and to provide more precise responses.

As shown in FIG. 1G, and by reference number 180, the video system 110 may process the modified input image and the one or more queries, with the MMLLM, to determine whether the video data contains graphic content. For example, the video system 110 may utilize the capabilities of the MMLLM for interpreting visual and textual data to assess, based on the one or more queries, the presence of graphic content within the modified input image. The one or more queries processed by the MMLLM may be formulated based on the sensitivity scores, to provide context to the MMLLM and to enhance an accuracy of the graphic content detection by the MMLLM. The video system 110 may leverage the advanced interpretative analytics of the MMLLM to evaluate the modified input image against the one or more queries, ensuring that content identified as potentially containing graphic content is accurately detected. In some implementations, the MMLLM may determine that the video data contains graphic content. Alternatively, the MMLLM may determine that the video data does not contain graphic content.

As further shown in FIG. 1G, and by reference number 185, the video system 110 may flag the video data based on the video data containing graphic content. For example, when the MMLLM determines that the video data contains graphic content, the video system 110 may flag the video data by marking the video data for special treatment, such as restricting access, providing warnings to viewers, disabling a preview of the video data in a video list page, preventing downloading of the video data, and/or the like. Flagging the video data may enable the video system 110 to manage the distribution of graphic content and to mitigate the exposure of viewers to potentially harmful content.

As further shown in FIG. 1G, and by reference number 190, the video system 110 may discard the video data based on the video data not containing graphic content. For example, when the MMLLM determines that the video data does not contain graphic content, the video system 110 may discard the video data or abstain from applying, to the video data, any special considerations relevant to graphic content. By discarding the video data or abstaining from censoring the video data, the video system 110 may streamline the content management process by ensuring that only content flagged as graphic is subjected to further scrutiny or restrictive measures.

As shown in FIG. 1H, and by reference number 195, the video system 110 may perform one or more actions based on the video data containing graphic content. In some implementations, performing the one or more actions includes the video system 110 disabling a preview of the video data in a video list page based on the video data containing graphic content. For example, the video system 110 may take measures to manage the dissemination and display of potentially sensitive video data to protect viewers from graphic content. The video system 110 may mitigate the risk of exposure by disabling a preview of the video data in a video list page when the content is deemed graphic. This may ensure that previewing the potentially distressing footage is not readily available without proper warning or consent. In this way, the video system 110 may conserve computing resources, networking resources, and/or other resources that would have otherwise been consumed by handling mental health issues associated with reviewers of the vehicle videos that contain graphic content.

In some implementations, performing the one or more actions includes the video system 110 disabling viewing of the video data based on the video data containing graphic content. For example, the video system 110 may enhance viewer protection by disabling the viewing of the video data based on its graphic content classification. This preemptive measure prevents accidental or unauthorized access to such sensitive material, thus safeguarding viewers from unintended distress. In this way, the video system 110 may conserve computing resources, networking resources, and/or other resources that would have otherwise been consumed by addressing the privacy and ethical issue associated with ensuring that graphic content is not downloadable or shareable.

In some implementations, performing the one or more actions includes the video system 110 preventing downloading of the video data based on the video data containing graphic content. For example, the video system 110 may actively prevent the downloading of the video data, once again based on the presence of graphic content. By restricting the download capability, the video system 110 may effectively diminish the risk of distributing the sensitive content, whether intentionally or inadvertently. In this way, the video system 110 may conserve computing resources, networking resources, and/or other resources that would have otherwise been consumed by training automatic graphic detection systems with human labelers that are susceptible to mental health issues.

In some implementations, performing the one or more actions includes the video system 110 displaying information warning that the video data contains graphic content and should only be viewed by approved personnel. For example, the video system 110 may display information that alerts potential viewers with a warning that the video data contains graphic content, which should be visualized solely by personnel with the necessary authorization. This may ensure that only viewers who are prepared and approved to handle such content are given access to it, thereby maintaining a level of responsible content management. In this way, the video system 110 may conserve computing resources, networking resources, and/or other resources that would have otherwise been consumed by handling mental health issues associated with reviewers of the vehicle videos that contain graphic content.

In some implementations, performing the one or more actions includes the video system 110 retraining the MMLLM based on the video data containing graphic content. For example, the video system 110 may utilize the video data containing graphic content as additional training data for retraining the MMLLM, thereby increasing the quantity of training data available for training the MMLLM. Accordingly, the video system 110 may conserve computing resources associated with identifying, obtaining, and/or generating historical data for training the MMLLM relative to other systems for identifying, obtaining, and/or generating historical data for training machine learning models.

In this way, the video system 110 detects and categorizes graphic content in vehicle videos. For example, the video system 110 may preemptively analyze vehicle videos using an MMLLM to detect and categorize graphic content, thus reducing the need for human reviewers to be exposed directly to such content. For example, the video system 110 may detect a set of candidate frames in a vehicle video that potentially contain graphic content based on aggregated sensitivity scores derived from object detection models and vehicle sensor data. The sensitivity scores may correlate with scenarios, such as a person injured inside or outside the vehicle, a hurt animal, or a dangerous event. The video system 110 may compile an image storyboard by horizontally concatenating selected frames of the vehicle video and may employ tailored queries to enable the MMLLM to ascertain the presence of graphic content. Additionally, the video system 110 may implement a selective masking operation on the storyboard image, wherein portions of the frame that are irrelevant to the analysis are obscured, concentrating efforts of the MMLLM on areas with potential graphic content and conserving processing resources.

Thus, the video system 110 may conserve computing resources, networking resources, and/or other resources that would have otherwise been consumed by handling mental health issues associated with reviewers of the vehicle videos that contain graphic content, addressing the privacy and ethical issue associated with ensuring that graphic content is not downloadable or shareable, training automatic graphic detection systems with human labelers that are susceptible to mental health issues, and/or the like. The video system 110 may significantly reduce the workload on processing resources by efficiently identifying frames of interest within extensive video data, and may conserve memory resources and network bandwidth that would be otherwise required for the transfer and storage of extensive unfiltered video data. Moreover, the video system 110 controls the dissemination of graphic content, thereby potentially preventing a breach of privacy and ensuring the dignity of individuals captured in the vehicle videos.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

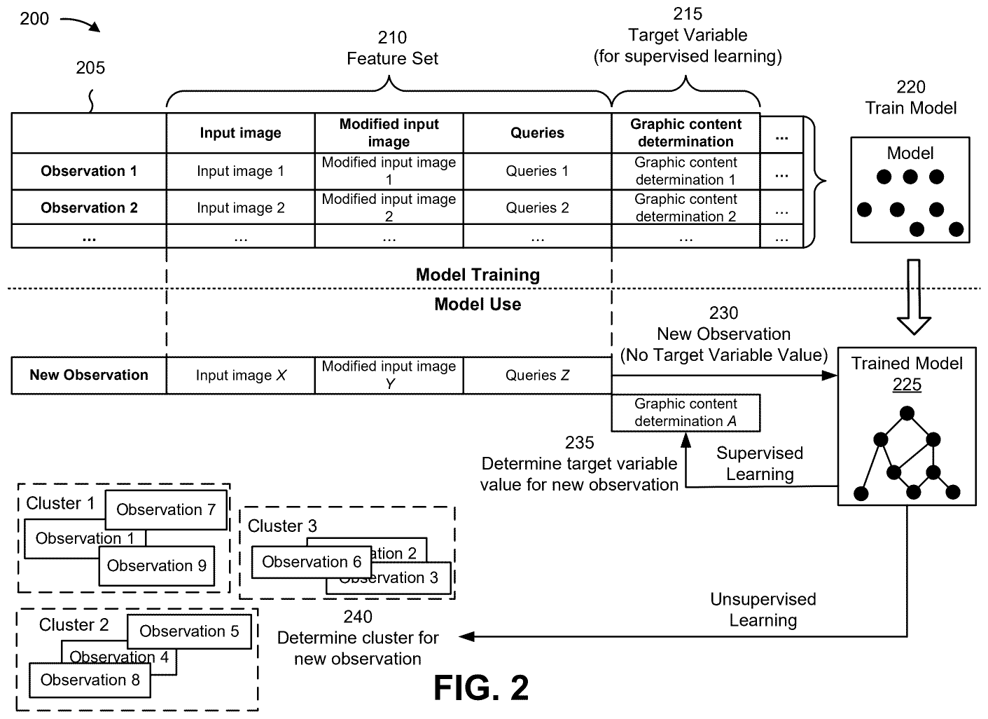

FIG. 2 is a diagram illustrating an example 200 of training and using a machine learning model for detecting and categorizing graphic content in vehicle videos. The machine learning model training and usage described herein may be performed using a machine learning system. The machine learning system may include or may be included in a computing device, a server, a cloud computing environment, and/or the like, such as the video system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the video system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the video system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of an input image, a second feature of a modified input image, a third feature of queries, and so on. As shown, for a first observation, the first feature may have a value of input image 1, the second feature may have a value of modified input image 1, the third feature may have a value of queries 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “graphic content determination” and may include a value of graphic content determination 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of input image X, a second feature of modified input image Y, a third feature of queries Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of graphic content determination A for the target variable of the graphic content determination for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., an input image cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a modified input image cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to detect and categorize graphic content in vehicle videos. The machine learning system enables recognition and/or identification of tens, hundreds, thousands, or millions of features and/or feature values for tens, hundreds, thousands, or millions of observations, thereby increasing accuracy and consistency and reducing delay associated with detecting and categorizing graphic content in vehicle videos relative to requiring computing resources to be allocated for tens, hundreds, or thousands of operators to manually detect and categorize graphic content in vehicle videos.

As indicated above, FIG. 2 is provided as an example. Other examples may differ from what is described in connection with FIG. 2.

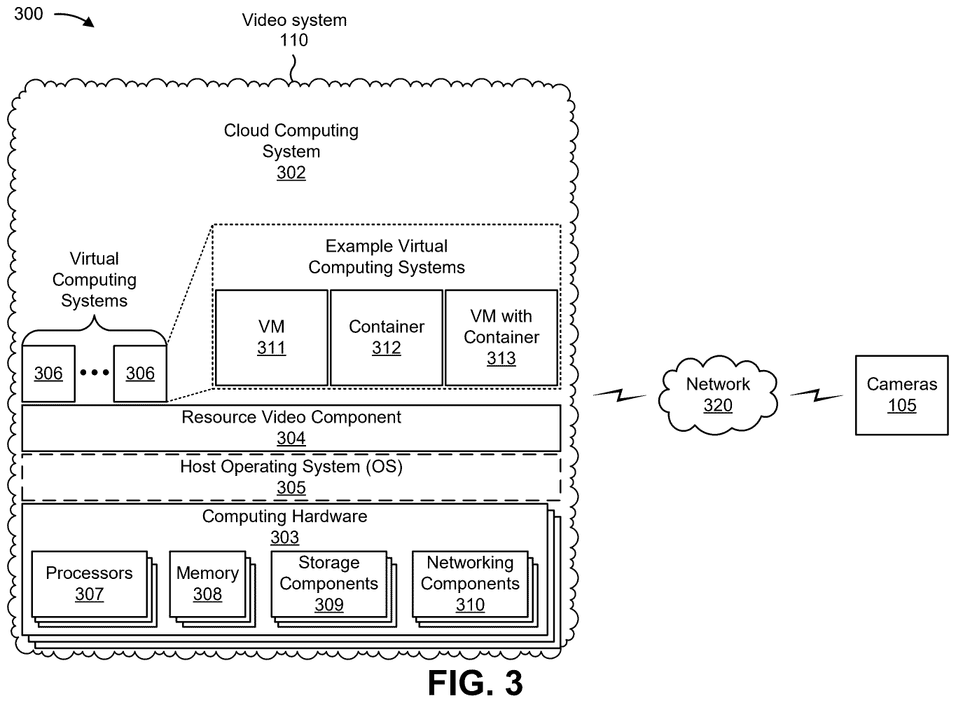

FIG. 3 is a diagram of an example environment 300 in which systems and/or methods described herein may be implemented. As shown in FIG. 3, the environment 300 may include the video system 110, which may include one or more elements of and/or may execute within a cloud computing system 302. The cloud computing system 302 may include one or more elements 303-313, as described in more detail below. As further shown in FIG. 3, the environment 300 may include the camera 105 and/or a network 320. Devices and/or elements of the environment 300 may interconnect via wired connections and/or wireless connections.

The camera 105 may include one or more devices capable of receiving, generating, storing, processing, providing, and/or routing information, as described elsewhere herein. The camera 105 may include a communication device and/or a computing device. For example, the camera 105 may include an optical instrument that captures videos (e.g., images and audio). The camera 105 may feed real-time video directly to a screen or a computing device for immediate observation, may record the captured video (e.g., images and audio) to a storage device for archiving or further processing, and/or the like. In some implementations, the camera 105 may include a dashcam of a vehicle, a forward facing camera of a vehicle, a driver facing camera of a vehicle, a side camera of a vehicle, a rear camera of a vehicle, and/or the like.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

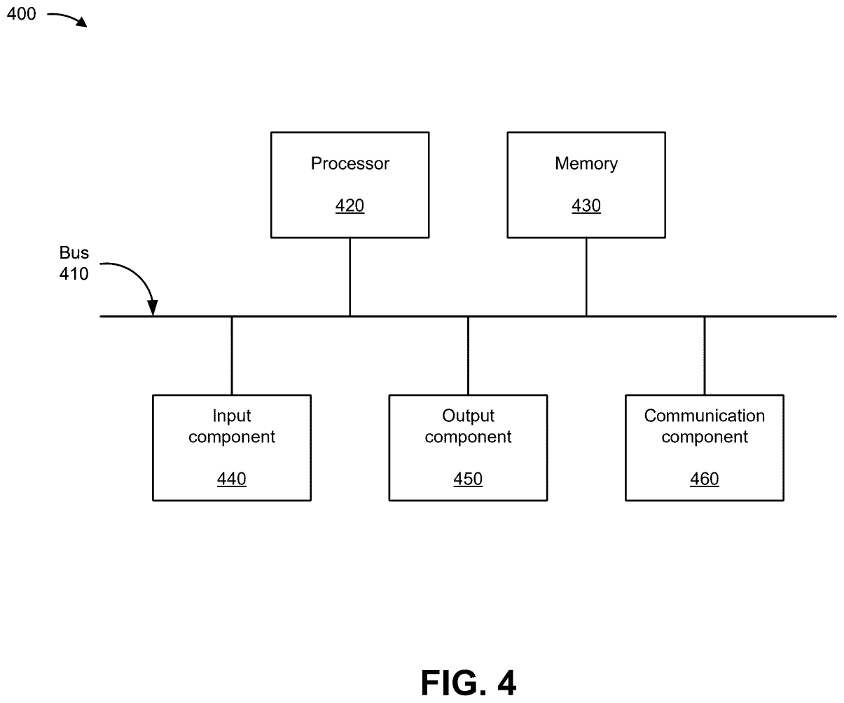

Although the video system 110 may include one or more elements 303-313 of the cloud computing system 302, may execute within the cloud computing system 302, and/or may be hosted within the cloud computing system 302, in some implementations, the video system 110 may not be cloud-based (e.g., may be implemented outside of a cloud computing system) or may be partially cloud-based. For example, the video system 110 may include one or more devices that are not part of the cloud computing system 302, such as a device 400 of FIG. 4, which may include a standalone server or another type of computing device. The video system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the camera 105 and/or the video system 110. In some implementations, the camera 105 and/or the video system 110 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

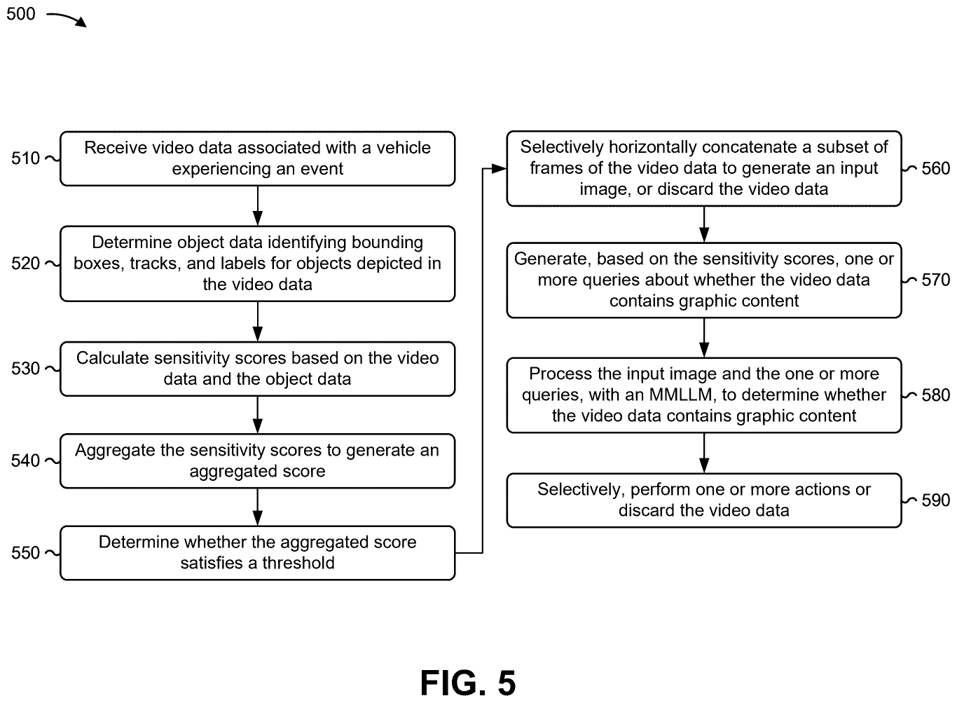

FIG. 5 depicts a flowchart of an example process 500 for detecting and categorizing graphic content in vehicle videos. In some implementations, one or more process blocks of FIG. 5 may be performed by a device (e.g., the video system 110). In some implementations, one or more process blocks of FIG. 5 may be performed by another device or a group of devices separate from or including the device, such as a control system of the vehicle, a camera (e.g., one of the cameras 105), and/or the like. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving video data associated with a vehicle experiencing an event (block 510). For example, the device may receive video data associated with a vehicle experiencing an event, as described above.

As further shown in FIG. 5, process 500 may include determining object data identifying bounding boxes, tracks, and labels for objects depicted in the video data (block 520). For example, the device may determine object data identifying bounding boxes, tracks, and labels for objects depicted in the video data, as described above. In some implementations, determining the object data includes utilizing an object detection model and an object tracking model to determine the object data identifying the bounding boxes, the tracks, and the labels for the objects depicted in the video data.

As further shown in FIG. 5, process 500 may include calculating sensitivity scores based on the video data and the object data (block 530). For example, the device may calculate, based on the video data and the object data, sensitivity scores indicating a likelihood that a person inside the vehicle is injured, a likelihood that a person outside the vehicle is injured, a likelihood that an animal is injured, or a dangerousness of the event, as described above. In some implementations, calculating one of the sensitivity scores indicating the likelihood that a person inside the vehicle is injured includes determining a shaking score that quantifies movement indicating potential injury within the vehicle, and calculating the one of the sensitivity scores indicating the likelihood that a person inside the vehicle is injured based on the shaking score.

In some implementations, calculating the sensitivity scores indicating the likelihood that a person outside the vehicle is injured or the likelihood that an animal is injured includes calculating, for objects classified as persons or animals, scores indicating rapid shrinkage of bounding box areas and upward movements of centers of the bounding box areas, and calculating the sensitivity scores indicating the likelihood that a person outside the vehicle is injured or the likelihood that an animal is injured based on the scores.

As further shown in FIG. 5, process 500 may include aggregating the sensitivity scores to generate an aggregated score (block 540). For example, the device may aggregate the sensitivity scores to generate an aggregated score, as described above. In some implementations, aggregating the sensitivity scores to generate the aggregated score includes applying a min-max normalization technique to transform the sensitivity scores into a normalized range corresponding to the aggregated score.

As further shown in FIG. 5, process 500 may include determining whether the aggregated score satisfies a threshold (block 550). For example, the device may determine whether the aggregated score satisfies a threshold, as described above.

As further shown in FIG. 5, process 500 may include selectively horizontally concatenating a subset of frames of the video data to generate an input image, or discarding the video data (block 560). For example, the device may selectively horizontally concatenate, based on the aggregated score satisfying the threshold, a subset of frames of the video data to generate an input image, or discard the video data based on the aggregated score failing to satisfy the threshold, as described above.

As further shown in FIG. 5, process 500 may include generating, based on the sensitivity scores, one or more queries about whether the video data contains graphic content (block 570). For example, the device may generate, based on the sensitivity scores, one or more queries about whether the video data contains graphic content, as described above.

As further shown in FIG. 5, process 500 may include processing the input image and the one or more queries, with an MMLLM, to determine whether the video data contains graphic content (block 580). For example, the device may process the input image and the one or more queries, with an MMLLM, to determine whether the video data contains graphic content, as described above. In some implementations, horizontally concatenating the subset of frames of the video data to generate the input image includes identifying bounding boxes in the input image based on the sensitivity scores, and performing a masking operation on the input image, except for the identified bounding boxes, to generate a modified input image, wherein processing the input image and the one or more queries, with the MMLLM, to determine whether the video data contains graphic content includes processing the modified input image and the one or more queries, with the MMLLM, to determine whether the video data contains graphic content.

As further shown in FIG. 5, process 500 may include selectively performing one or more actions or discarding the video data (block 590). For example, the device may selectively perform one or more actions based on the video data containing graphic content, or discard the video data based on the video data not containing graphic content, as described above. In some implementations, performing the one or more actions includes one or more of disabling a preview of the video data in a video list page based on the video data containing graphic content, or disabling viewing of the video data based on the video data containing graphic content. In some implementations, performing the one or more actions includes one or more of preventing downloading of the video data based on the video data containing graphic content, or displaying information warning that the video data contains graphic content and should only be viewed by approved personnel. In some implementations, performing the one or more actions includes retraining the MMLLM based on the video data containing graphic content. In some implementations, performing the one or more actions includes one or more of blurring a preview of the video data in a video list page based on the video data containing graphic content, or blurring portions of the video data that contain graphic content.

In some implementations, process 500 includes discarding the video data and ceasing processing of the video data based on the event not being assigned a major severity or a critical severity. In some implementations, process 500 includes adjusting the sensitivity scores based on telematics sensor data representing dynamics of the vehicle during the event. In some implementations, process 500 includes receiving a request from the MMLLM based on processing the input image and the one or more queries with the MMLLM, generating a response to the request, and providing the response to the MMLLM.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, video data associated with a vehicle experiencing an event;
determining, by the device, object data identifying objects depicted in the video data;
calculating, by the device and based on the video data and the object data, sensitivity scores indicating a likelihood of injury or a dangerousness of the event;
aggregating, by the device, the sensitivity scores to generate an aggregated score;
determining, by the device, whether the aggregated score satisfies a threshold;
selectively:
horizontally concatenating, by the device and based on the aggregated score satisfying the threshold, a subset of frames of the video data to generate an input image, or
discarding, by the device, the video data based on the aggregated score failing to satisfy the threshold;
generating, by the device and based on the sensitivity scores, one or more queries about whether the video data contains graphic content;
prompting, by the device, a multi-modal large language model (MMLLM), with the input image and the one or more queries, to determine whether the video data contains graphic content; and
performing, by the device, one or more actions based on the video data containing graphic content.

2. The method of claim 1, wherein determining the object data comprises:
utilizing an object detection model and an object tracking model to determine the object data identifying bounding boxes, tracks, and labels for the objects depicted in the video data.

3. The method of claim 1, further comprising:
discarding the video data and ceasing processing of the video data based on the event not being assigned a major severity or a critical severity.

4. The method of claim 1, wherein horizontally concatenating the subset of frames of the video data to generate the input image comprises:
identifying bounding boxes in the input image based on the sensitivity scores; and
performing a masking operation on the input image, except for the identified bounding boxes, to generate a modified input image,
wherein prompting the MMLLM, with the input image and the one or more queries, to determine whether the video data contains graphic content comprises:
prompting the MMLLM, with the modified input image and the one or more queries, to determine whether the video data contains graphic content.

5. The method of claim 1, wherein performing the one or more actions comprises one or more of:
disabling a preview of the video data in a video list page based on the video data containing graphic content; or
disabling viewing of the video data based on the video data containing graphic content.

6. The method of claim 1, wherein performing the one or more actions comprises one or more of:
preventing downloading of the video data based on the video data containing graphic content; or
displaying information warning that the video data contains graphic content and should only be viewed by approved personnel.

7. The method of claim 1, wherein performing the one or more actions comprises:
retraining the MMLLM based on the video data containing graphic content.

8. A device, comprising:
one or more processors configured to:
receive video data associated with a vehicle experiencing an event;
determine object data identifying bounding boxes, tracks, and labels for objects depicted in the video data;
calculate, based on the video data and the object data, sensitivity scores indicating a likelihood that a person inside the vehicle is injured, a likelihood that a person outside the vehicle is injured, a likelihood that an animal is injured, or a dangerousness of the event;
aggregate the sensitivity scores to generate an aggregated score;
determine whether the aggregated score satisfies a threshold;
horizontally concatenate, based on the aggregated score satisfying the threshold, a subset of frames of the video data to generate an input image;
generate, based on the sensitivity scores, one or more queries about whether the video data contains graphic content;
process the input image and the one or more queries, with a multi-modal large language model (MMLLM), to determine whether the video data contains graphic content; and
perform one or more actions based on the video data containing graphic content.

9. The device of claim 8, wherein the one or more processors are further configured to:
adjust the sensitivity scores based on telematics sensor data representing dynamics of the vehicle during the event.

10. The device of claim 8, wherein the one or more processors, to aggregate the sensitivity scores to generate the aggregated score, are configured to:
apply a min-max normalization technique to transform the sensitivity scores into a normalized range corresponding to the aggregated score.

11. The device of claim 8, wherein the one or more processors, to calculate one of the sensitivity scores indicating the likelihood that a person inside the vehicle is injured, are configured to:
determine a shaking score that quantifies movement indicating potential injury within the vehicle; and
calculate the one of the sensitivity scores indicating the likelihood that a person inside the vehicle is injured based on the shaking score.

12. The device of claim 8, wherein the one or more processors, to calculate the sensitivity scores indicating the likelihood that a person outside the vehicle is injured or the likelihood that an animal is injured, are configured to:
calculate, for objects classified as persons or animals, scores indicating rapid shrinkage of bounding box areas and upward movements of centers of the bounding box areas; and
calculate the sensitivity scores indicating the likelihood that a person outside the vehicle is injured or the likelihood that an animal is injured based on the scores.

13. The device of claim 8, wherein the one or more processors are further configured to:
receive a request from the MMLLM based on processing the input image and the one or more queries with the MMLLM;
generate a response to the request; and
provide the response to the MMLLM.

14. The device of claim 8, wherein the one or more processors, to perform the one or more actions, are configured to one or more of:
blur a preview of the video data in a video list page based on the video data containing graphic content; or
blur portions of the video data that contain graphic content.

15. A non-transitory computer-readable medium storing a set of instructions, the set of instructions comprising:
one or more instructions that, when executed by one or more processors of a device, cause the device to:
receive video data associated with a vehicle experiencing an event;
determine object data identifying bounding boxes, tracks, and labels for objects depicted in the video data;
calculate, based on the video data and the object data, sensitivity scores indicating a likelihood that a person inside the vehicle is injured, a likelihood that a person outside the vehicle is injured, a likelihood that an animal is injured, or a dangerousness of the event;
aggregate the sensitivity scores to generate an aggregated score;
determine whether the aggregated score satisfies a threshold;
horizontally concatenate, based on the aggregated score satisfying the threshold, a subset of frames of the video data to generate an input image;
generate, based on the sensitivity scores, one or more queries about whether the video data contains graphic content;
process the input image and the one or more queries, with a multi-modal large language model (MMLLM), to determine whether the video data contains graphic content; and
selectively:
perform one or more actions based on the video data containing graphic content, or
discard the video data based on the video data not containing graphic content.

16. The non-transitory computer-readable medium of claim 15, wherein the one or more instructions, that cause the device to determine the object data, cause the device to:
utilize an object detection model and an object tracking model to determine the object data identifying the bounding boxes, the tracks, and the labels for the objects depicted in the video data.

17. The non-transitory computer-readable medium of claim 15, wherein the one or more instructions, that cause the device to horizontally concatenate the subset of frames of the video data to generate the input image, cause the device to:
identify bounding boxes in the input image based on the sensitivity scores; and
perform a masking operation on the input image, except for the identified bounding boxes, to generate a modified input image,
wherein the one or more instructions, that cause the device to process the input image and the one or more queries, with the MMLLM, to determine whether the video data contains graphic content, cause the device to:
process the modified input image and the one or more queries, with the MMLLM, to determine whether the video data contains graphic content.

18. The non-transitory computer-readable medium of claim 15, wherein the one or more instructions, that cause the device to perform the one or more actions, cause the device to one or more of:
disable a preview of the video data in a video list page based on the video data containing graphic content;
disable viewing of the video data based on the video data containing graphic content;
prevent downloading of the video data based on the video data containing graphic content;
display information warning that the video data contains graphic content and should only be viewed by approved personnel; or
retrain the MMLLM based on the video data containing graphic content.

19. The non-transitory computer-readable medium of claim 15, wherein the one or more instructions further cause the device to:
adjust the sensitivity scores based on telematics sensor data representing dynamics of the vehicle during the event.

20. The non-transitory computer-readable medium of claim 15, wherein the one or more instructions, that cause the device to aggregate the sensitivity scores to generate the aggregated score, cause the device to:
apply a min-max normalization technique to transform the sensitivity scores into a normalized range corresponding to the aggregated score.
